(19) United States
(12) Patent Application Publication
(10) Pub. No.: US 2002/0060277 A1
(43) Pub. Date: May 23, 2002

(54) ARMREST FOR HANDLING A COMPUTER

(76) Inventors: Hong-Tai Tsai, Tainan City (TW); Hui-Ping Chou, Tainan City (TW)

Correspondence Address: Hong-Tai Tsai, 3F, No. 7, Lane 6, Chung-Te 2nd St., Tainan City, TW

(21) Appl. No.: 09/756,583

(22) Filed: Jan. 5, 2001

(30) Foreign Application Priority Data
Nov. 22, 2000 (TW) 89220522

(51) Int. Cl. B68G 5/00; F16B 1/00

(52) U.S. Cl. 248/118; 248/229.24; 248/274.1

(57) ABSTRACT

A armrest for handling a computer includes a base to be fixed adjustably on an armrest of a chair, two clamps combined with a bottom side of the base to define a clamp space to clamp the armrest of the chair, a mouse plate combined with a front side of the base for placing and handling the mouse of a computer and able to be adjusted in its angle. An extension base can be additionally combined with firmly with the base for placing a cup, an ashtray, etc. An armrest plate is deposited on the base for supporting an arm of a user to let him/her to handle the mouse or a keyboard of a computer with comfort and easiness.

### BACKGROUND OF THE INVENTION

This invention relates to an armrest for handling a mouse of a computer, particularly to one fixed on an armrest of a chair for a user of a computer to handle comfortably and feely a mouse or a keyboard of a computer, reducing occupational harm computer users may suffer.

A known conventional armrest for handling a computer disclosed in U.S. Pat. No. 5,074,501 includes an armrest for handling a computer to reduce tiredness and pain of hands of a user, clamped on a sidewall of a table. A user handles a mouse or a keyboard of a computer with a posture sitting near the screen of a terminal, but cannot has complete function to permit the hands comfortable. In addition, a keyboard and a mouse is connected with a computer in a wireless mode recently, so a user can handle the computer from a comparatively far place, so the known conventional armrest just mentioned may hardly meet this demand.

### SUMMARY OF THE INVENTION

This invention has been devised to offer an armrest for handling the mouse and the keyboard of a computer with comfort and freedom, clamped on an armrest of a chair. One feature of the invention is a base fixed on an armrest of a chair by means of clamps.

Another feature of the invention is a mouse plate provided in front of the base and adjustable its angle to suit to using condition and custom of a user.

One more feature of the invention is an extension base connected at one side of the base for placing stationary, an ashtray, a cup, etc. for the user to use.

### BRIEF DESCRIPTION OF DRAWINGS

This invention will be better understood by referring to the accompanying drawings, wherein:

FIG. 1 is an exploded perspective view of an armrest for handling a computer in the present invention;

FIG. 2 is a partial exploded perspective view of the armrest for handling a computer in the present invention;

FIG. 3 is a perspective view of the armrest for handling a computer in the present invention;

FIG. 4 is another perspective view of the armrest for handling a computer in the present invention;

FIG. 5 is an upper view of the armrest for handling a computer in the present invention;

FIG. 6 is a side view of the armrest for handling a computer in the present invention;

FIG. 7 is a side view of the armrest for handling a computer in the present invention, showing it being moved in one way;

FIG. 8 is a side view of the armrest for handling a computer in the present invention, showing it being moved in another way; and,

FIG. 9 is a side view of the armrest for handling a computer in the invention fixed on an armrest of a chair.

### DETAILED DESCRIPTION OF THE PREFERRED EMBODIMENT

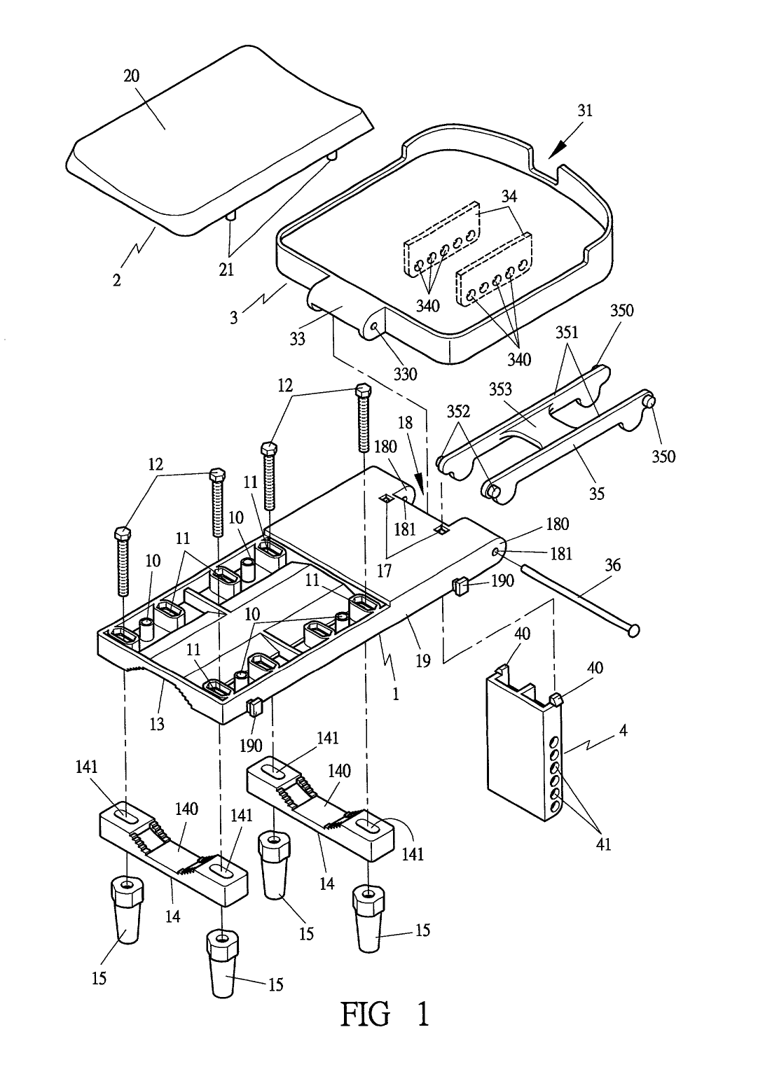

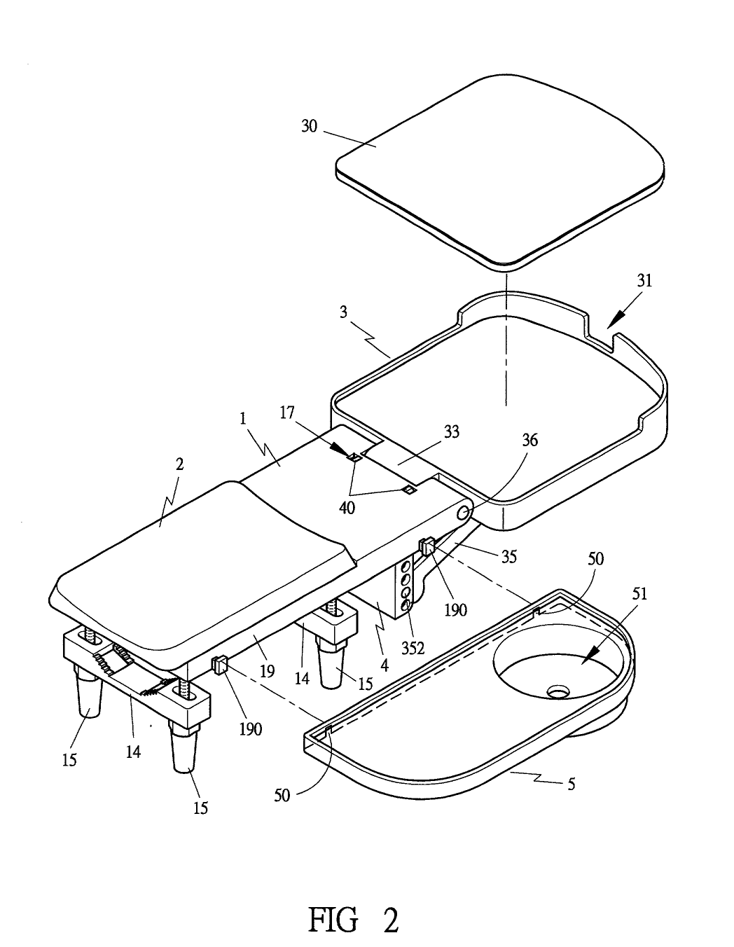

This preferred embodiment of an armrest for handling a computer in the present invention, as shown in FIGS. 1 and 2, includes a base 1, an armrest plate 2, a mouse plate 3, an angle adjusting base 4, and an extension base 5 as main components combined together.

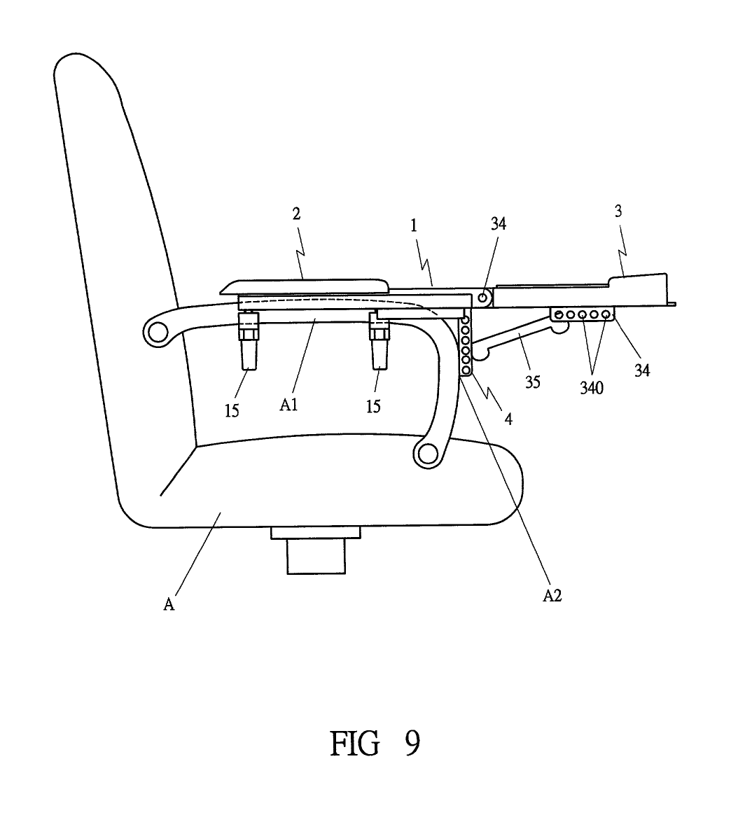

The base 1 has plural stud holes 10 spaced apart on front portions of two lengthwise sides for combine the armrest therein, plural rectangular through holes 11 spaced apart on the front portions of the two lengthwise sides and each pair of the through holes 11 located at two sides of each stud hole 10 for screws 12 to pass through. Further the base 1 has a concave clamp surface 13 formed on an intermediate portion of a bottom side, and two clamps 14 are provided to have respectively a clamp surface 140 to face the clamp surface 13 of the base 1. The two clamps 14 further have respectively a rectangular through holes 141 at two ends for screws to pass through first the rectangular through holes 13 of the base and then pass through to engage with nuts 15 to define a clamp space 16 between the two clamps 14 and the clamp surface 13 of the base 1, as shown in FIG. 2. Then an armrest A1 of a chair A can be clamped in the clamp space 16, as shown in FIG. 9, and the length of the clamp space 16 clamping the armrest A1 can be adjusted by altering any of the rectangular through holes 11 of the base for the screws to pass through, and in addition, the rectangular through holes 11 can be applied to various width of the armrest of chairs. The base 1 further has a recess 18 formed in an inner side wall and two square holes 17 bored at two sides of the recess 18, and a shaft hole 181 formed respectively in two side walls 180 of the recess 18, and two engage blocks 190 fixed spaced apart at two end portions of a lengthwise side 19.

The armrest plate 2 has a concave upper surface 20, plural studs 21 extending down from a bottom side to fit in the stud holes 10 of the base to deposit the armrest plate 2 on the base 1.

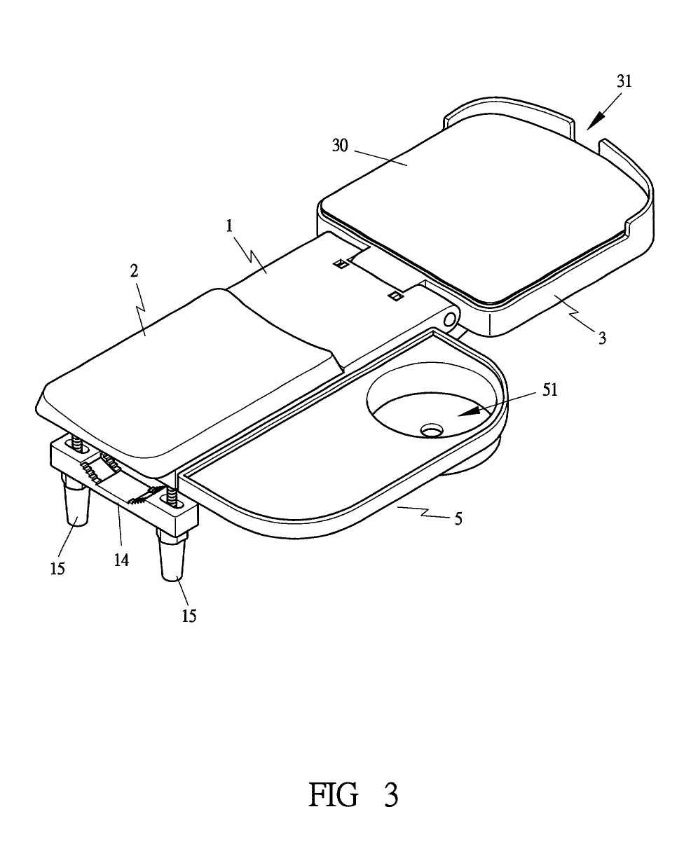

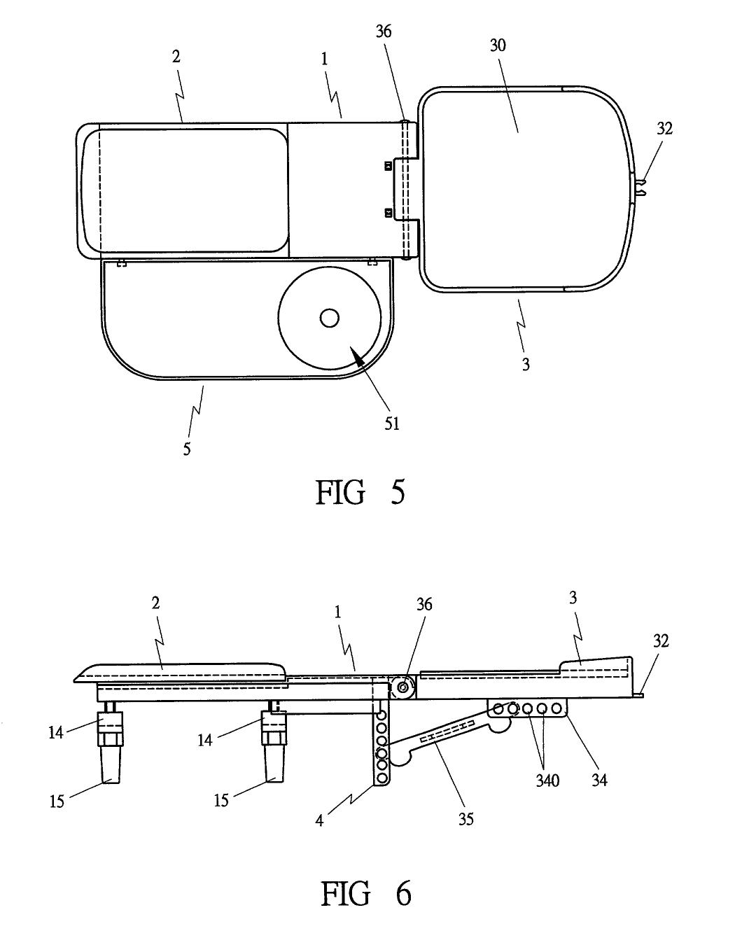

The mouse plate 3 has a mouse sheet 30 laid on an upper surface, an aperture 31 formed in an intermediate portion of a front side wall, thread hooks 32 provided under the aperture 31 for hooking a wire of a mouse. The mouse plate 3 further has a shaft support 33 formed on a rear side wall and fitting in the recess 18 of the base 1 and bored with a shaft hole 330 for a shaft 36 to fit therein and also in the shaft hole 181 of the recess 18 of the base 1 to combine the mouse plate 3 with the base 1, as shown in FIGS. 3, 4 and 5. Further, two parallel vertical walls 34 of a certain length are provided under the bottom of the mouse plate 3, having respectively plural small holes 340 spaced apart horizontally in a line. An angle adjusting member 35 is provided to have two front buttons 350 fixed on front ends of two parallel rods 351 and two rear buttons 352 on rear ends of the two parallel rods 351, and a linking intermediate surface 353 formed between intermediate portions of the two parallel rods 351 to permit the two parallel rods 351 to expand or shrink, as shown in FIGS. 6 an 7 and 8.

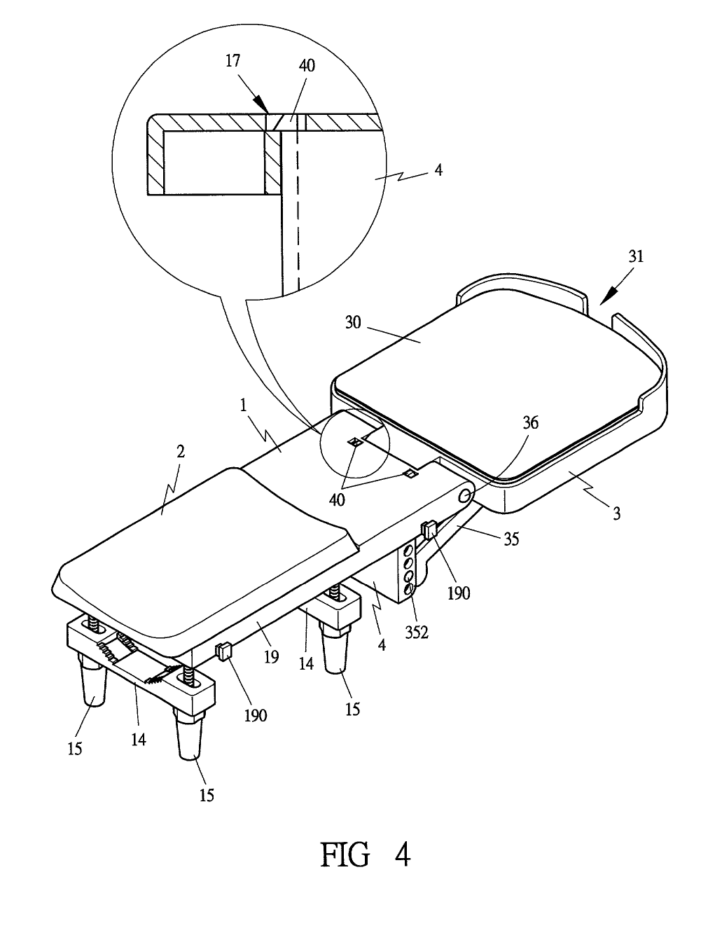

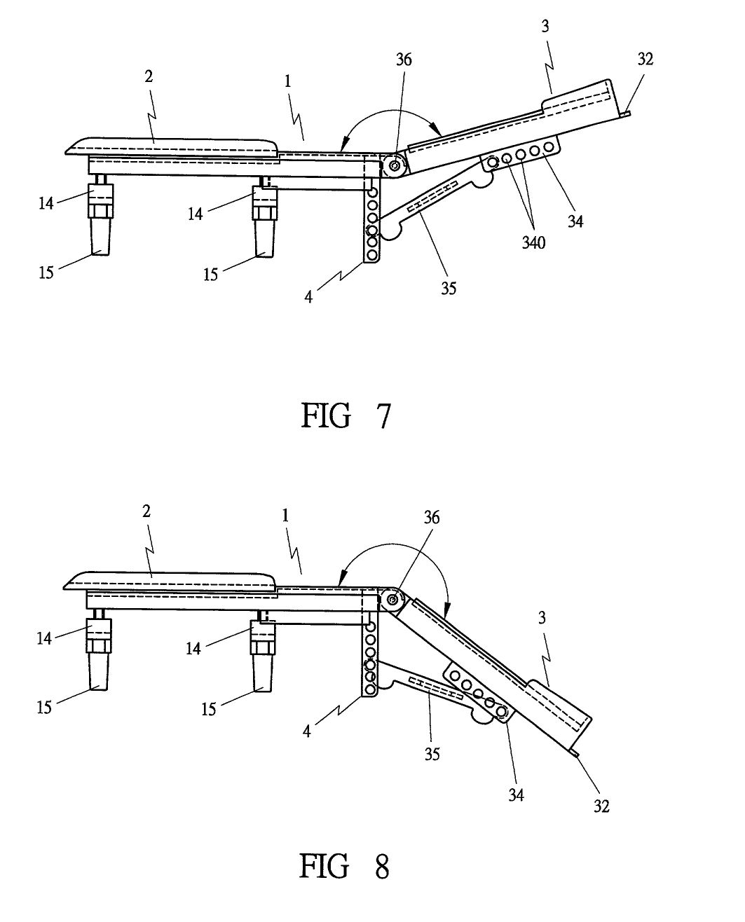

The angle adjuster base 4 has two hooks 40 formed at two upper opposite ends to hook in the square hole 17 of the base 1, as shown in FIG. 4, securing the angle adjuster base 4 with the base 1, and plural small holes 41 formed spaced apart respectively in two opposite side walls to fit with the rear buttons 352. Then engaging locations of the front buttons 350 with the small holes 340 and those of the rear buttons 352 with the small holes 41 can alter combining location between the angle adjuster base 4 and the mouse plate 3 so as to permit the mouse plate 3 alter its angle freely, as shown in FIGS. 6, 7 and 8. In this invention, the armrest is combined with an armrest A1 of a chair A by means of the angle adjuster base 4 pushes the front end surface A2 of the armrest A1, so the armrest for handling the computer in the invention is stabilized stably when in use.

In addition, an extension base 5 may be combined with the base 1, having a rail groove 50 fitting with the rail blocks 190 of the base 1 to secure it with the base 1, and a recess 51 for placing an ashtray, a cup, and a stationary case, for the benefit of use. In general, the armrest for handling a computer in the invention can be easily fixed on the armrest of a chair for a user to rest his/her hands whether left-handed or right handed thereon and with his/her back resting on the backrest in handling the mouse of a computer with comfort and easiness, reducing occupational harm and tired feeling.

What is claimed is:

1. An armrest for handling a computer comprising:
A base having a clamp surface formed in an intermediate portion of a bottom surface, two clamps provided respectively with a clamp surface to face said clamp surface of said base, said clamp surface of said base and said clamp surfaces of said two clamps defining a clamp space between;
An armrest plate having a concave upper surface, and plural studs extending down and spaced apart from a bottom surface to fit in holes provided in said base;
A mouse plate having a shaft base formed on a rear end wall and having a shaft hole for a shaft to fit in to combine with said base, and two parallel vertical walls extending down from a bottom surface for combining with front buttons of an angle adjusting rod;
An angle adjuster member having two parallel rods provided with two front buttons and two rear buttons to permit said two parallel rods expand and shrink;
An angle adjusting base secured fixedly in said base, permitting combining location between said angle-adjusting base and said mouse plate freely alterable so as to permit said mouse plate alter its angle freely; and,
An extension base possible to be additionally combined with said base firmly.

2. The armrest for handling a computer as claimed in claim 1, wherein said base has plural rectangular through holes, and said two clamps also have plural rectangular through holes for screws to pass through said through holes of said base and said through holes of said clamps to form said clamp space for clamping an armrest of a chair.

3. The armrest for handling a computer as claimed in claim 1, wherein said base has a recess formed in an intermediate portion of an inner sidewall, and two square holes bored near two sides of said recess, two side walls of said recess respectively having a shaft hole; one lengthwise wall of said base has plural projecting outward rail blocks so as to combine with said angle adjusting base and said mouse plate and said extension base.
